(19) United States
(12) Patent Application Publication
(10) Pub. No.: US 2026/0162281 A1
(43) Pub. Date: Jun. 11, 2026

(54) INFORMATION PROCESSING APPARATUS AND CONTROL METHOD THEREOF

(71) Applicant: CANON KABUSHIKI KAISHA, Tokyo (JP)

(72) Inventor: Junichi SAITO, Kanagawa (JP)

(21) Appl. No.: 19/407,041

(22) Filed: Dec. 3, 2025

(30) Foreign Application Priority Data
Dec. 6, 2024 (JP) 2024-213835

(51) Int. Cl. G06T 7/246; G06T 7/571; G06V 10/25; G06V 10/74

(52) U.S. Cl. CPC G06T 7/248; G06T 7/571; G06V 10/25; G06V 10/761; G06T 2207/10016; G06T 2207/30196; G06V 2201/07

(57) ABSTRACT

An information processing apparatus obtains a frame image included in a moving image, obtains depth information regarding a depth in each region in the frame image, sets a tracking target, detects one or more tracking candidates similar to the tracking target from the frame image, and identify the tracking target from the one or more tracking candidates based on a degree of similarity between the tracking target in a past frame image preceding the frame image and each of the one or more tracking candidates in the frame image.

### BACKGROUND

### Field of the Technology

The present disclosure relates to a technique for tracking a subject in a moving image.

### Description of the Related Art

Techniques for tracking a specific subject in a moving image include a technique using luminance and color information and a technique using template matching. In recent years, a technique using a deep neural network (DNN) has been attracting attention.

Bertinetto et al., “Fully-Convolutional Siamese Networks for Object Tracking”, arXiv: 1606.09549, 2016 discloses a tracking method using a convolutional neural network (CNN). Specifically, the position of a tracking target in an image of a search range is identified by inputting each of an image of the tracking target and the image of the search range to a CNN having an identical weight and calculating cross-correlation between the respective feature amounts obtained from the CNN. Japanese Patent Laid-Open No. 2018-88233 discloses a technique of improving tracking accuracy by obtaining three-dimensional (vertical, horizontal, and depth) position information on an object and predicting current positions of a plurality of objects based on respective pieces of past position information on the plurality of objects.

However, in the above-described method, since detection is performed from the image feature amount, there is a problem that erroneous tracking is prone to occur in a case where a plurality of objects similar to the tracking target closely exist in the image.

### SUMMARY

The present disclosure provides a technique that enables more accurate subject tracking.

An information processing apparatus comprises: at least one processor; and at least one memory having stored thereon instructions which, when executed by the at least one processor, causing the information processing apparatus at least to: obtain a frame image included in a moving image, obtain depth information regarding a depth in each region in the frame image, set a tracking target, detect one or more tracking candidates similar to the tracking target from the frame image, and identify the tracking target from the one or more tracking candidates based on a degree of similarity between the tracking target in a past frame image preceding the frame image and each of the one or more tracking candidates in the frame image, wherein the degree of similarity is based on at least one of a first degree of similarity between a depth of the tracking target in the past frame image and a depth of each of the one or more tracking candidates, a second degree of similarity between position and size of a bounding box (BB) of the tracking target in the past frame image and position and size of a BB of each of the one or more tracking candidates, and a third degree of similarity between an image feature of the tracking target in the past frame image and an image feature of each of the one or more tracking candidates.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a hardware configuration of an information processing apparatus.

FIG. 2 is a view illustrating a functional configuration of the information processing apparatus (at the time of inference processing).

FIG. 3 is an overall flowchart of inference processing.

FIG. 4 is a view illustrating, by way of example, a plurality of objects detected from an image.

FIG. 5 is a detailed flowchart of S303.

FIG. 6 is a detailed flowchart of S305.

FIGS. 7A and 7B are views illustrating a situation in which position detection of a tracking target has succeeded/failed.

FIG. 8 is a flowchart showing processing in a CNN.

FIG. 9 is a detailed flowchart of S306.

FIG. 10 is a view illustrating a relationship between a defocus amount and a phase difference between two focus detection signals.

FIG. 11 is a view illustrating a functional configuration of the information processing apparatus (at the time of learning processing).

FIG. 12 is a flowchart of learning processing.

FIGS. 13A and 13B are views illustrating examples of a template image and a search range image.

FIGS. 14A and 14B are views illustrating examples of an inference result and a ground truth.

FIGS. 15A to 15C are views describing object tracking using depth information.

FIG. 16 is a detailed flowchart of S306 in a case of using reliability of depth information.

FIG. 17 is a view illustrating a temporal change of a focus lens position of the image capturing apparatus.

FIGS. 18A and 18B are detailed flowcharts of S306 (second embodiment).

FIGS. 19A to 19C are views describing updating of a feature amount obtainment position using depth information.

FIGS. 20A and 20B are detailed flowcharts of S306 (third embodiment).

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As the first embodiment of an information processing apparatus according to the present disclosure, an apparatus that performs object tracking processing using a neural network (NN) will be described below as an example. In particular, a form of suppressing erroneous tracking in which a similar object is erroneously tracked by tracking a tracking target using depth information will be described.

### Apparatus Configuration

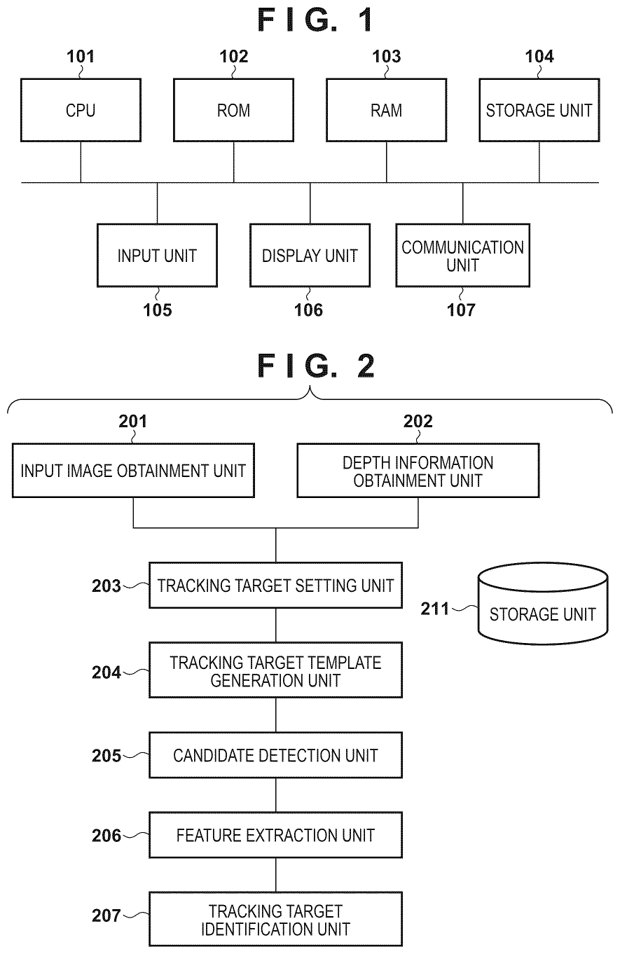

FIG. 1 is a view illustrating a hardware configuration of an information processing apparatus (computer) in the first embodiment. A CPU 101 controls the entire apparatus by executing a control program stored in a ROM 102. A RAM 103 temporarily stores various data from each component and operates as a work memory of the CPU 101.

A storage unit 104 stores data that is a processing target in the present embodiment, and stores data to be a tracking target. As a medium of the storage unit 104, a hard disk drive (HDD), a flash memory, various optical media, and the like can be used. An input unit 105 includes a keyboard, a touch panel, and a dial or the like, receives input from a user, and is used when setting a tracking target described later. A display unit 106 includes a liquid crystal display or the like, and provides a subject image and a tracking result to the user by image display. A communication unit 107 is a functional unit for the information processing apparatus to communicate with another apparatus such as a shooting apparatus.

### Inference Processing

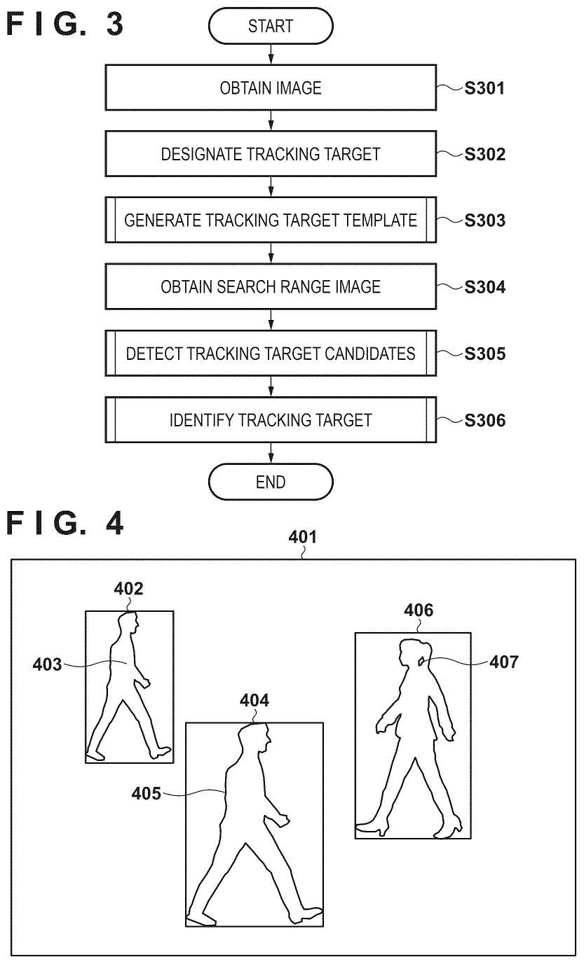

FIG. 2 is a view illustrating a functional configuration of the information processing apparatus at the time of inference processing. FIG. 3 is an overall flowchart of inference processing. However, an information processing apparatus 1 needs not necessarily perform all the processes described in this flowchart. Processing executed by the CPU 101 is illustrated as functional blocks.

In S301, an input image obtainment unit 201 obtains an image (frame image included in a moving image) in which a person is captured. A depth information obtainment unit 202 obtains (depth obtainment) information regarding the depth (depth in each region in a frame image) in the image obtained by the input image obtainment unit 201. Note that the input image obtainment unit 201 may obtain an image captured by an image capturing apparatus connected to the information processing apparatus 1, or may obtain an image stored in the storage unit 104. The depth information obtainment unit 202 may obtain depth information from the image capturing apparatus connected to the information processing apparatus 1, or may obtain depth information stored in the storage unit 104.

In S302, a tracking target setting unit 203 determines a tracking target in an image in accordance with an instruction designated via the input unit 105. As a specific method of determining the tracking target, there is a method of determining the tracking target by the user touching the subject displayed on the display unit 106. Note that the tracking target may be determined by automatically detecting a main subject or the like in the image in addition to being designated by the input unit 105. Methods of automatically detecting a main subject in an image include one in Document A, for example. The tracking target may be determined based on both designation by the input unit 105 and the object detection result in the image. Techniques for detecting an object from an image include one in Document B.
(Document A) Japanese Patent No. 6556033
(Document B) Liu et al., “SSD: Single Shot Multibox Detector”, arXiv:1512.02325, ECCV, 2016

FIG. 4 is a view illustrating, by way of example, a plurality of objects detected from an image. Objects 403, 405, and 407 are each detected tracking target candidates. Rectangles 402, 404, and 406 are bounding boxes (BB) indicating candidates. The user can determine the tracking target by touching or selecting, with a dial or the like, any of the BBs indicated on the display unit 106. There are various methods for determining the tracking target in this manner, and the method is not limited to the above-described method.

In S303, a tracking target template generation unit 204 generates a template (tracking target template) representing a feature of the tracking target determined by the tracking target setting unit 203.

In S304, the input image obtainment unit 201 obtains a search range image (e.g., frame image subsequent to the image in S301).

In S305, a candidate detection unit 205 detects one or more candidates of the tracking target (one or more tracking candidates) designated by the tracking target setting unit 203 from the search range image. A feature extraction unit 206 extracts, from the image, a feature of the tracking target candidate obtained by the candidate detection unit 205.

In S306, a tracking target identification unit 207 identifies, as a tracking target, a candidate most likely to be a tracking target from among the one or more candidates obtained by the candidate detection unit 205.

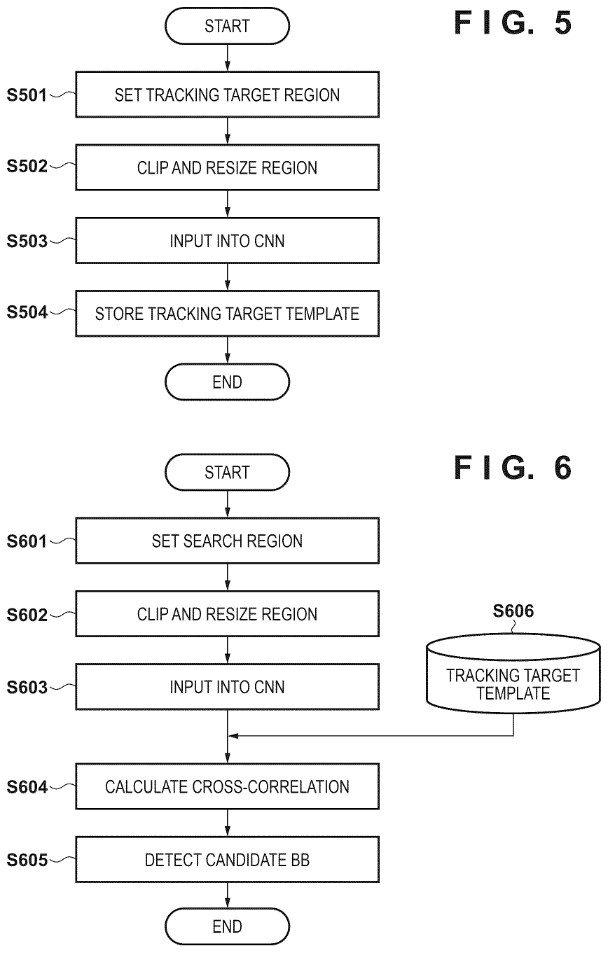

FIG. 5 is a detailed flowchart of tracking target template generation (S303). The tracking target setting unit 203 generates a template for representing the tracking target based on the image obtained by the input image obtainment unit 201 and the BB of the tracking target obtained by the tracking target setting unit 203.

In S501, the tracking target template generation unit 204 identifies a region where the tracking target exists based on the BB of the tracking target obtained by the tracking target setting unit 203.

In S502, the tracking target template generation unit 204 clips, from the image, a periphery of the region obtained in S501, and resizes the image to a predetermined size.

In S503, the tracking target template generation unit 204 inputs the resized image to the CNN. The CNN is learned in advance so as to obtain a feature amount that makes it easy to distinguish between a tracking target and a non-tracking target. A learning method will be described later.

In S504, the tracking target template generation unit 204 stores, as a tracking target template, the feature amount obtained in S503.

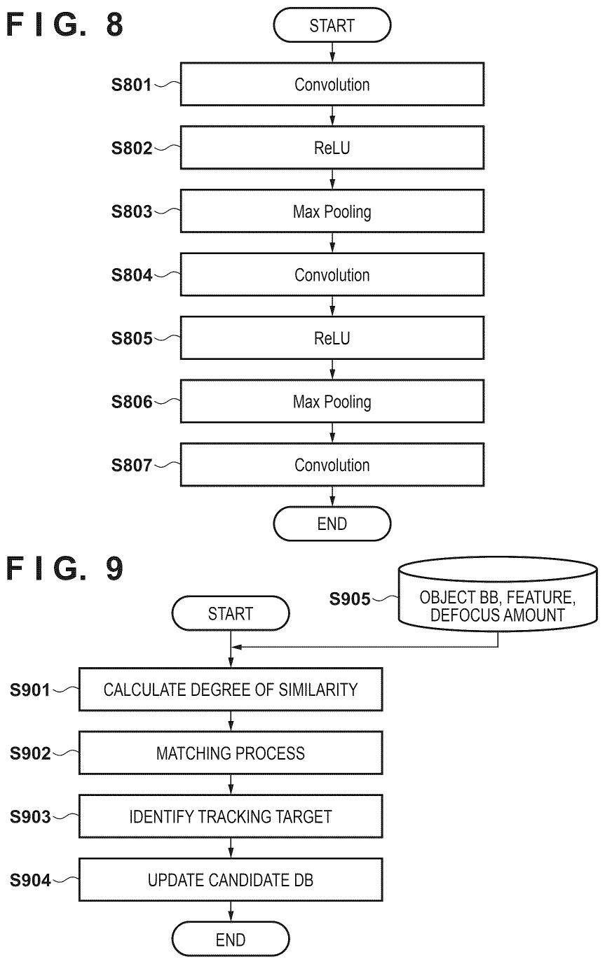

FIG. 8 is a flowchart showing processing in the CNN in S503. The CNN includes superimposition of a convolution layer, a rectified linear unit (ReLU) layer, a max pooling layer, and the like.

Note that ReLU and max pooling described here are merely examples. Leaky ReLU, PRelu, GELU, Sigmoid function, or the like may be used in place of ReLU, or average pooling or the like may be used in place of max pooling. A network configuration that is not CNN but vision transformer, MLP mixer, or the like may be adopted. Vision transformer is disclosed in detail in Document C, and MLP mixer is disclosed in detail in Document D. However, the network configuration to be used is not limited to these.
(Document C) Dosovitskiy et al., “An Image is Worth 16×16 Words: Transformers for Image Recognition at Scale”, arXiv:2010.11929, 2020
(Document D) Tolstikhin et al., “MLP-Mixer: An all-MLP Architecture for Vision”, arXiv:2105.01601, 2021

FIG. 6 is a detailed flowchart of candidate detection (S305). In S305, an object is to detect a tracking target from the image serving as a search range obtained in S304.

In S601, the candidate detection unit 205 determines a region for searching for a candidate. The search region may be the entire search image or may be around the position of the previous tracking target.

In S602, the candidate detection unit 205 clips a region based on the determined search region, and resizes the region to match the resizing ratio in S502.

In S603, the candidate detection unit 205 inputs the image of the clipped region to the CNN. The CNN in S603 has a weight partially or entirely identical to that of the CNN in S503.

In S606, the candidate detection unit 205 obtains the tracking target template obtained in S504. In S604, the candidate detection unit 205 calculates cross-correlation between the tracking target template and the result obtained in S603. At this time, since the CNN in S603 and the CNN in S503 have weights partially or entirely identical to each other, the value of cross-correlation increases at a position with a high probability that the tracking target exists within the search range. Therefore, a position where the value of cross-correlation is a threshold or more can be detected as a position of the tracking target candidate. Here, the tracking target candidate represents one or more candidates that can be the tracking target. The tracking target candidate includes one or both of a tracking target and a non-tracking target.

In S605, the candidate detection unit 205 detects, as a candidate BB, the tracking target candidate obtained in S604. In order to obtain a BB, not only the position but also the width and height of the BB are needed. The position of the BB is determined based on a position showing a high reaction in cross-correlation.

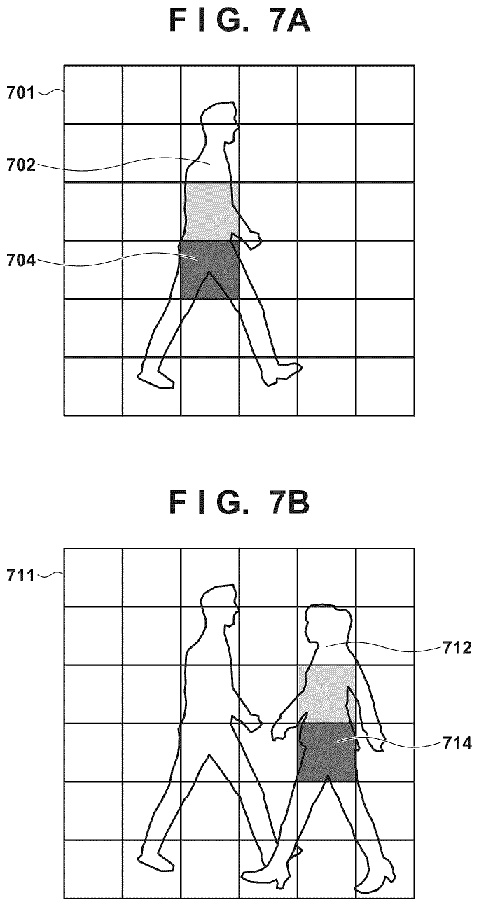

FIG. 7A is a view illustrating a situation in which position detection of the tracking target has succeeded, and FIG. 7B is a view illustrating a situation in which position detection of the tracking target has failed.

A map 701 indicates a map obtained based on the cross-correlation. The tracking target is an object 702, and the cross-correlation value of a cell 704 near the center of the object 702 indicates a high value. When the correlation value is the threshold or more, the object 702 can be estimated to be positioned in the cell 704.

Note that as illustrated in FIG. 7B, in a case where an object 712 having a similar image feature closely exists at this time, there is also a case where the object 702 of the tracking target has a high value of cross-correlation of the cell 714. In a case where a position different from the position where the object of the tracking target exists is estimated, the feature of the object 712 is obtained as a feature of the object 702 of the tracking target, and erroneous tracking in which the tracking target switches from the object 702 to the object 712 occurs. Therefore, in S306, it is necessary to identify an accurate tracking target by performing matching between the tracking target and the similar object using depth information.

Note that the width and height of the BB may be learned so that the CNN can estimate them in advance (described later). The width and height of the BB that is the tracking target obtained in S302 may be used as they are.

FIG. 9 is a detailed flowchart of tracking target identification (S306). The tracking target identification unit identifies the tracking target from among the tracking target candidates obtained by the candidate detection unit 205.

In S905, the tracking target identification unit 207 obtains the object BB, the feature amount, and the depth information on the input image obtained by the depth information obtainment unit 202.

In S901, the tracking target identification unit 207 calculates the degree of similarity between a candidate in an image at a past time (past frame image) stored in advance in a storage unit 211 and a candidate at the current time obtained by the candidate detection unit 205. Note that the past frame image is a frame image preceding a frame image of interest where the tracking target is currently being detected. The past candidate is assigned a label of tracking target/non-tracking target. The object BB, the feature amount, and the depth information are used to calculate the degree of similarity. Here, a description will be given using a defocus amount as depth information. However, as the depth information, depth information measured using, for example, a time-of-flight (ToF) reflective laser sensor may be used.

The defocus amount (defocus) is a deviation in an image forming plane obtained by multiplying an image shift amount calculated from a pair of images (image A and image B described later) having parallax by a predetermined conversion coefficient. Information on a defocus amount distribution in which a defocus amount is allocated to a predetermined pixel region of an imaging plane is called a defocus map. Note that as a unit of defocus amount in the present disclosure, a product [F8] of an aperture F number and a permissible circle of confusion diameter δ in an image capturing apparatus optical system at the time of image shooting is used.

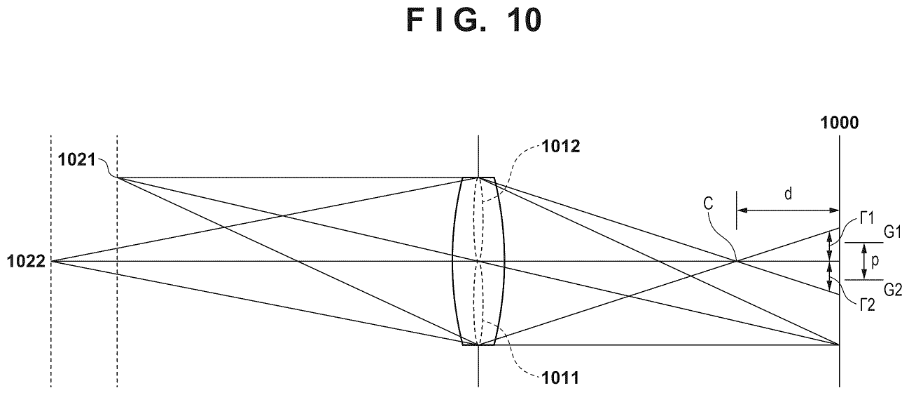

FIG. 10 is a view illustrating a relationship between a defocus amount of an image capturing optical system and a phase difference between two focus detection signals. Here, a phase difference (image shift amount) between a first focus detection signal and a second focus detection signal obtained from an image capturing element is illustrated.

An image capturing element (not illustrated) is disposed on an imaging plane 1000, and an exit pupil of the image capturing optical system is divided into two of a first pupil region 1011 and a second pupil region 1012.

A defocus amount d is defined such that a “front focus state” in which an image forming position C is on the subject side relative to the imaging plane 1000 is represented by a negative sign (d<0) with the distance (magnitude) from the image forming position C of a light flux from subjects 1021 and 1022 to the imaging plane 1000 being |d|. The image forming position C is defined such that a “back focus state” in which the image forming position C is on the opposite side of the imaging plane 1000 from the subject is represented by a positive sign (d>0). In an in-focus state where the image forming position C is on the imaging plane 1000, d=0. The image capturing optical system is in the in-focus state (d=0) with respect to the subject 1021 and is in the front focus state (d<0) with respect to the subject 1022. The front focus state (d<0) and the back focus state (d>0) are collectively referred to as a defocus state (|d|>0).

In the front focus state (d<0), the light flux passing through the first pupil region 1011 among the light fluxes from the subject 1022 is once collected, and then spreads to a width Γ1 about a centroid position G1 of the light flux, and forms an out-of-focus image on the imaging plane 1000. This out-of-focus image is received by each first focus detection pixel on the image capturing element, and the first focus detection signal is generated. That is, the first focus detection signal is a signal representing a subject image in which the subject 1022 is out of focus by the out-of-focus width Γ1 at the centroid position G1 of the light flux on the imaging plane 1000. Similarly, the second focus detection signal is a signal representing a subject image in which the subject 1022 is out of focus by an out-of-focus width Γ2 at a centroid position G2 of the light flux on the imaging plane 1000.

The out-of-focus widths Γ1 and Γ2 of the subject image increase substantially in proportion to an increase in the magnitude |d| of the defocus amount d. Similarly, the magnitude |p| of the image shift amount p(=the difference G1−G2 between the centroid positions of the light fluxes) between the first focus detection signal and the second focus detection signal also increases substantially in proportion to the increase in the magnitude |d| of the defocus amount d. Even in the back focus state (d>0), the image shift direction between the first focus detection signal and the second focus detection signal is opposite to that in the front focus state, but is similar.

As described above, the magnitude of the image shift amount between the first and second focus detection signals increases as the magnitude of the defocus amount increases. In the present embodiment, imaging-plane phase-difference detection method focus detection that calculates a defocus amount from an image shift amount between first and second focus detection signals obtained using an image capturing element is performed. Note that in the following description, the first and second focus detection signals are called an A image and a B image, respectively.

As an example of the degree of similarity calculation in S901 described above, a degree L of similarity between a past candidate c₁ and a current candidate c₂ is calculated as in Expression (1).

$$L ( {c}_{1} , {c}_{2} ) = - {W}_{1} ‖ {BB}_{1} - B {B}_{2} ‖ - {W}_{2} ‖ {f}_{1} - {f}_{2} ‖ - {W}_{3} ‖ {e}_{1} - {e}_{2} ‖ \qquad ( 1 )$$

Here, BB is a vector in which four variables of (center coordinate value x, center coordinate value y, width, and height) of each candidate BB are put together, and f indicates a feature of each candidate. The feature is obtained by extracting a feature in which each candidate is positioned from the feature map obtained from the CNN described above. e₁ and e₂ indicate defocus amounts of the past candidate c₁ and the current candidate c₂. W₁, W₂, and W₃ are empirically obtained coefficients, respectively, and W₁>0, W₂>0, and W₃>0.

In S902, the tracking target identification unit 207 performs matching based on the degree of similarity between the past candidate and the current candidate calculated in S901. A high degree of similarity between the past candidate and the current candidate indicates that there is a high possibility that the corresponding past candidate and the corresponding current candidate are identical objects. By appropriately performing matching, the past tracking target and the current tracking target can be recognized as identical objects. As a matching method, other methods such as a method of preferentially matching candidates having a high degree of similarity and a method using Hungarian Algorithm can be used.

In S903, the tracking target identification unit 207 identifies the tracking target. As a result of the matching obtained in S902, the current candidate matched with the past tracking target can be identified as the tracking target.

In S904, the tracking target identification unit 207 updates the BB, the feature, and the defocus amount of the tracking target and a candidate thereof stored in a DB. Note that in the present embodiment, data is held as it is regarding a past candidate not matched with a candidate at the current time point at the time of DB update, but the present disclosure is not limited to this. For example, the system capacity may be saved by erasing past candidate information for which matching has not occurred even after being held for a predetermined time.

Note that in the present embodiment, the defocus amount of each candidate is obtained from the above-described defocus map superimposed on the image. The defocus amount of each candidate is obtained from the vicinity of the candidate range of each candidate (e.g., an estimated position of a cross-correlation result, a mean value of adjacent regions, and the like). The obtainment method of the defocus amount of each candidate is not limited to this. For example, by using an image, a defocus map, and a subject defocus inference unit that has learned a defocus amount of the subject as a ground truth (GT), the influence of a close view, a distant view, and the like is eliminated, and an accurate defocus amount of the subject may be inferred and obtained. The defocus amount may have not a value at one point but a maximum/minimum value as a value for a range in which the subject exists. Furthermore, in a case where depth information is used, depth information on a region where the subject exists may be obtained by depth estimation or the like. The depth estimation method is disclosed in detail in Document E.
(Document E) Huynh et al., “Boosting Monocular Depth Estimation with Lightweight 3D Point Fusion”, arXiv:2012.10296, 2020

In the present embodiment, a form in which both the tracking target and the similar object are held in the DB, and the past candidate and the current candidate are matched is presented, but for example, the information held in the DB may be only the object BB of the tracking target, the feature amount, and the depth information. In this case, the matching in S902 can be skipped, and a candidate indicating a value most similar to the tracking target in S903 may be identified as a tracking target from the result of degree of similarity calculation between the tracking target and each current candidate in S901.

### Learning Processing

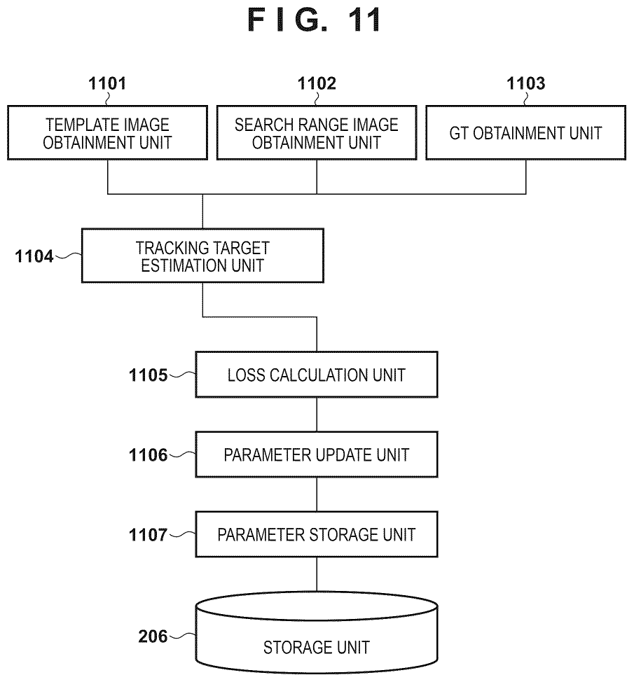

The learning processing of the CNN used for search for a tracking target will be described. FIG. 11 is a view illustrating a functional configuration of the information processing apparatus at the time of learning processing. An information processing apparatus 2 includes a template image obtainment unit 1101, a search range image obtainment unit 1102, a GT obtainment unit 1103, a tracking target estimation unit 1104, a loss calculation unit 1105, a parameter update unit 1106, a parameter storage unit 1107, and the storage unit 211.

The template image obtainment unit 1101 obtains an image in which a tracking target exists. The search range image obtainment unit 1102 obtains an image that is a target for searching for the tracking target. For example, the template image obtainment unit 1101 selects an arbitrary frame from a sequence video, and the search range image obtainment unit 1102 selects another frame not selected by the template image obtainment unit 1101 from the sequence video.

The GT obtainment unit 1103 obtains the BB of the tracking target in a template image obtained by the template image obtainment unit 1101 and the BB of the tracking target in a search range image obtained by the search range image obtainment unit 1102.

The tracking target estimation unit 1104 estimates the tracking target based on the template image obtained by the template image obtainment unit 1101, the search range image obtained by the search range image obtainment unit 1102, and the BB of the tracking target obtained by the GT obtainment unit 1103.

The loss calculation unit 1105 calculates a loss based on a tracking result obtained by the tracking target estimation unit 1104 and the BB of the tracking target in the search range image obtained by the GT obtainment unit 1103.

The parameter update unit 1106 updates the parameters of the CNN based on the loss obtained in the loss calculation unit 1105. Here, the parameters are updated such that the loss value converges. In a case where the sum of the loss value converges or in a case where the loss value becomes smaller than a predetermined value, a parameter set is updated and the learning is ended.

The parameter storage unit 1107 stores the parameters of the CNN updated by the parameter update unit 1106 in the storage unit 211 as learned parameters.

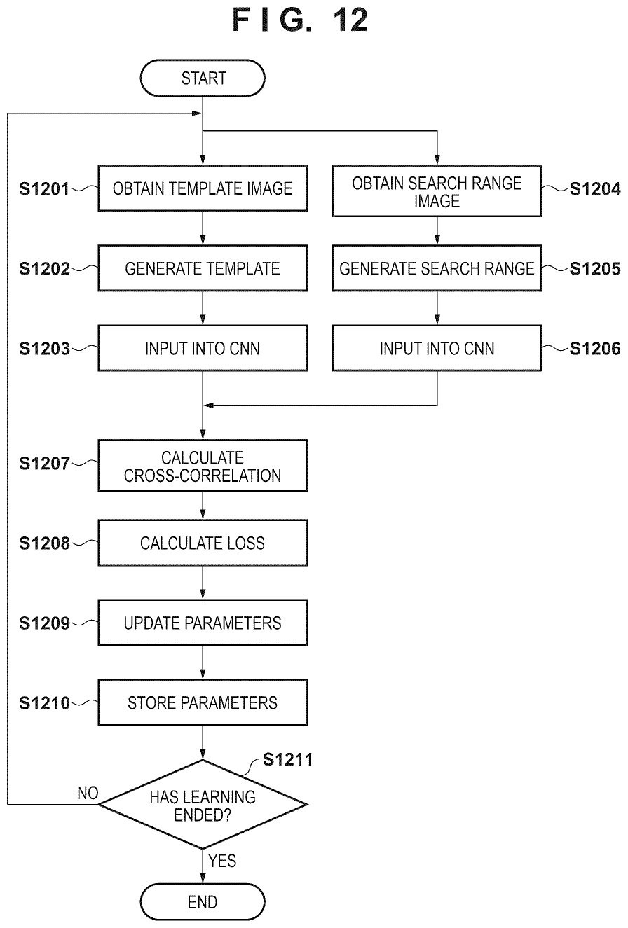

FIG. 12 is a flowchart of learning processing.

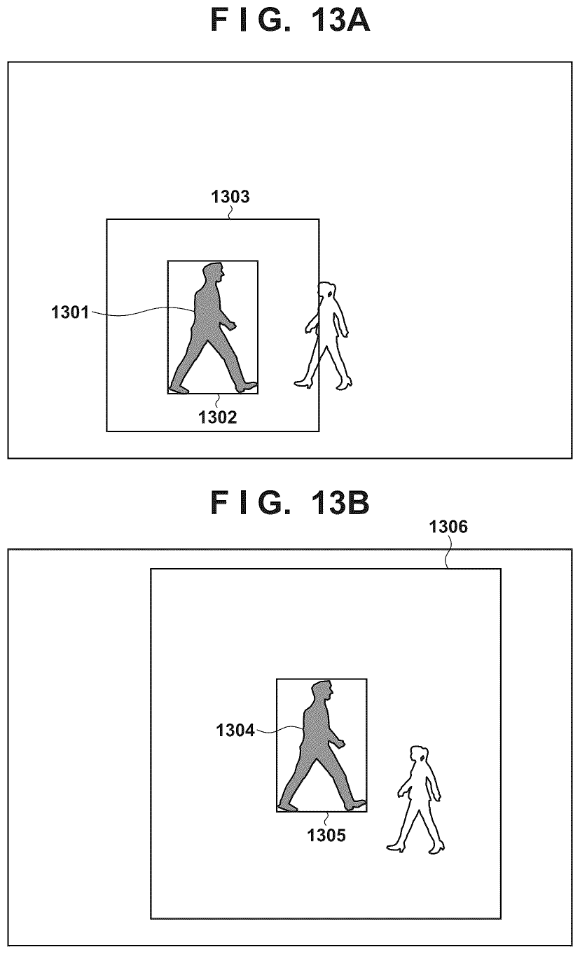

In S1201, the template image obtainment unit 1101 obtains the template image. FIGS. 13A and 13B are views illustrating examples of a template image and a search range image. An object 1301 is a tracking target, a rectangle 1302 indicates a BB of the tracking target obtained by the GT obtainment unit 1103, and a rectangle 1303 indicates a region to be clipped as a template.

In S1202, the template image obtainment unit 1101 clips a region to be a template from the template image and resizes the region to a predetermined size. The size of the region to be clipped is determined as a constant multiple of the size of the BB based on the BB of the tracking target.

In S1203, the tracking target estimation unit 1104 inputs the template image generated in S1202 to the CNN, and obtains a CNN feature of the template.

In S1204, the search range image obtainment unit 1102 obtains an image. An object 1304 indicates a tracking target, a rectangle 1305 indicates a BB of the tracking target, and a rectangle 1306 indicates a region of a search range.

In S1205, the search range image obtainment unit 1102 clips the search range region from the image obtained in S1204 to resize it, and generates a search range image. The size of the search range image is determined to be a constant multiple of the size of the BB of the tracking target, and resized in accordance with the magnification used to resize the template in S1202. For example, the search range image is resized such that the size of the tracking target in the resized template and the size of the tracking target in the search range image are approximately identical.

In S1206, the tracking target estimation unit 1104 inputs the search range image generated in S1205 to the CNN, and obtains the CNN feature of the search range.

In S1207, the tracking target estimation unit 1104 calculates cross-correlation between the CNN feature of the template obtained in S1206 and the CNN feature of the search range obtained in S1206.

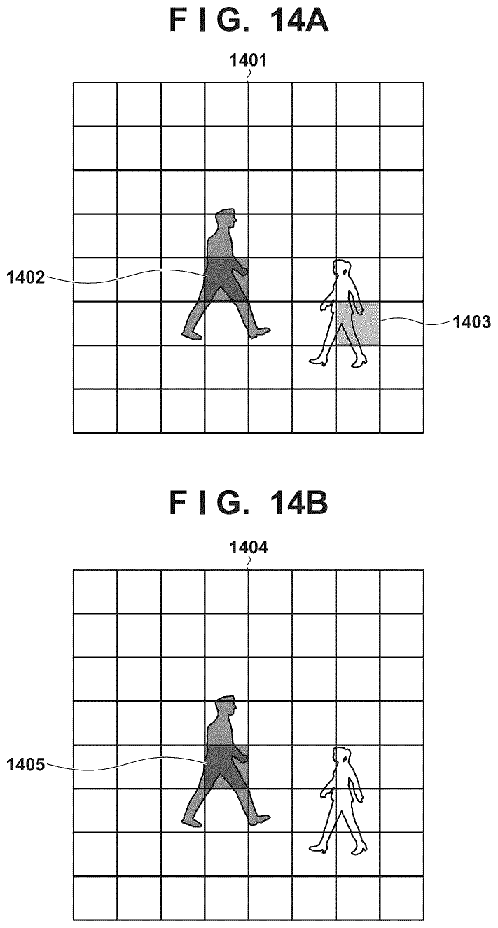

FIG. 14A is a view illustrating an example of a map (inference result) obtained by the cross-correlation. A map 1401 is a map obtained by the cross-correlation, and cells 1402 and 1403 indicated in gray indicate portions having high cross-correlation values. In this manner, the cross-correlation value is high at a position having a high possibility of being the tracking target.

FIG. 14B illustrates the ground truth (cell 1405 at the position of a tracking target that is a correct answer) obtained by GT obtainment unit 1103. That is, it can be said that since the cell 1402 indicates the position of the tracking target, a desirable value is estimated, but since the cross-correlation value is high although the cell 1403 is not the tracking target, an undesirable value is estimated. In the learning processing, the weight is updated such that the cross-correlation value at the position of the tracking target is high and the cross-correlation value at the position other than the tracking target is low.

In S1208, the loss calculation unit 1105 calculates a loss related to the inferred position of the tracking target and the loss related to the size of the tracking target. The loss related to the position is calculated such that the cross-correlation value of the position of the tracking target indicates a high value. When the map 1401 obtained in S1207 is Cin and a GT map 1404 is Cgt, the loss function can be described as Expression (2).

$${Loss}_{C} = \frac{1}{N} \sum {( {C}_{in} - {C}_{gt} )}^{2} \qquad ( 2 )$$

Expression (2) is a mean of squares of differences for each pixel of the map Cin and the map Cgt, and the loss decreases in a case where the tracking target can be correctly estimated, and the loss increases in a case where a non-tracking target is estimated to be the tracking target or the tracking target is estimated to be a non-tracking target.

Similarly, the loss related to size is calculated in accordance with Expressions (3) and (4).

$${Loss}_{W} = \frac{1}{N} \sum {( {W}_{in} - {W}_{gt} )}^{2} \qquad ( 3 )$$

$${Loss}_{H} = \frac{1}{N} \sum {( {H}_{in} - {H}_{gt} )}^{2} \qquad ( 4 )$$

LossW and LossH are losses related to the width and height, respectively, of the tracking target having been estimated. In Wgt and Hgt, the value of the width and the value of the height, respectively, of the tracking target are embedded at the position of the tracking target. By calculating the losses by Expressions (3) and (4), learning proceeds such that the width and height of the tracking target are inferred at the position of the tracking target also in Win and Hin. The above three losses are integrated into Expression (5).

$$Loss = {Loss}_{C} + {Loss}_{W} + {Loss}_{H} \qquad ( 5 )$$

Here, the loss is described in the form of mean square error (MSE), but the description of loss is not limited to MSE. Smooth-L1 or the like may be used. The calculation expression of loss is not limited. The loss function related to the position and the loss function related to the size may be different.

In S1209, the parameter update unit 1106 updates the parameters of the CNN based on the loss calculated in S1208. The updating of the parameters is performed based on backpropagation by using Momentum SGD or the like. Note that although output of the loss function for one image has been described, the actual learning calculates the loss value of Expression (2) for the scores estimated for a variety of images. A combination weighting coefficient between layers of a learning model is updated such that the loss values of the plurality of images are all smaller than a predetermined threshold.

In S1210, the parameter storage unit 1107 stores, in the storage unit 211, the parameters of the CNN updated in S1209. In the inference processing, inference (FIG. 3) is performed using the parameters stored in S1210.

In S1211, it is determined whether to end the learning. In the end determination of learning, it is determined that the learning is ended, for example, in a case where the value of the loss obtained by Expression (2) becomes smaller than the predetermined threshold.

### Effect

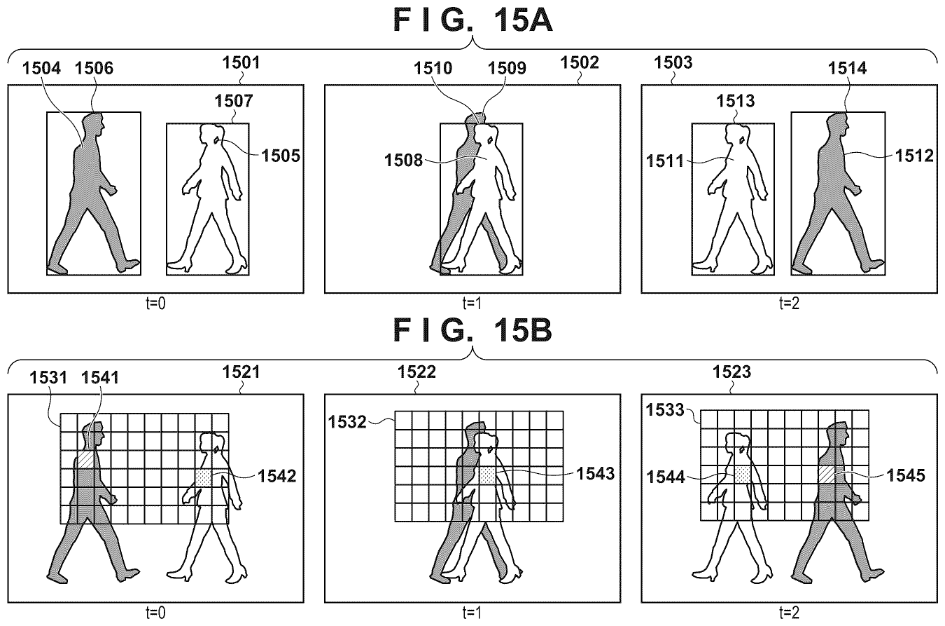

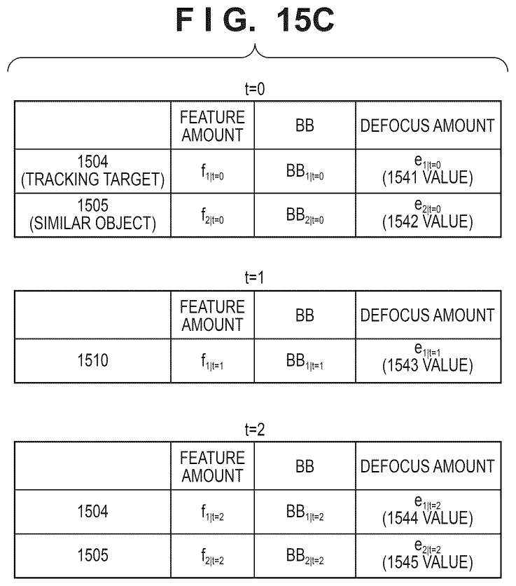

FIGS. 15A to 15C are views describing object tracking using depth information. Specifically, they illustrate a situation in which the tracking target and an object similar to the tracking target are simultaneously tracked using a defocus map.

Images 1501, 1502, and 1503 in FIG. 15A illustrate images obtained at times t=0, t=1, and t=2, respectively. The images show a person 1504 and a person 1505, of which the tracking target is the person 1504 and the similar object is the person 1505.

In images 1521, 1522, and 1523 in FIG. 15B, defocus maps generated at times t=0, t=1, and t=2, respectively, are superimposed and displayed on the images at respective times in FIG. 15A. The defocus maps at respective times are indicated by grids 1531, 1532, and 1533, respectively, and each is assumed to have a defocus amount in units of cells in which the grid is divided.

At time t=0, cells 1541 and 1542 are assumed to be cells adopted from the maps as defocus amounts indicating the depths of the persons 1504 and 1505. At time t=1, a cell 1543 is assumed to be a cell adopted as a defocus amount indicating the depth of a person 1508. Furthermore, at time t=2, cells 1544 and 1545 are assumed to be cells adopted as defocus amounts indicating the depths of persons 1511 and 1512. FIG. 15C illustrates information on the feature amount, the BB, and the defocus amount obtained at each time.

First, a case where the tracking target and the similar object are tracked only with the image feature amount and the BB as in a known manner (case of not using a defocus amount that is depth information) will be considered. In this case, at time t=0, tracking is started simultaneously with the person 1504, who is the tracking target, and the person 1505, who is the similar object. At time t=1, a person 1509 is shielded by the person 1508. At this time, the person 1508 detected as a candidate is matched with either the person 1504 or the person 1505 at t=0.

A case is considered in which a feature amount “filt=0” of the tracking target at t=0 and a feature amount “f_{2|t=0}” of the similar object are very similar, and a difference hardly occurs with respect to the BB. In such a case, there is a possibility that the candidate 1510 and the similar object 1505 match as a result of performing the degree of similarity calculation. As a result, at time t=1, the person 1508 is identified as the tracking target, and a switch occurs from the person 1509, who is the original tracking target. Also at time t=2, if the person 1511 is continuously matched as the tracking target from the previous time, the person 1512, who is the original tracking target, cannot be tracked, and the tracking fails.

On the other hand, tracking of a tracking target using a defocus amount is considered according to the first embodiment described above. At time t=0, it is assumed that the person 1504, who is the tracking target, is on the rear side, and the person 1505, who is the similar object, is on the front side. In this case, the magnitude relationship between the values of the defocus amounts “e_{1|t=0}” and “e_{2|t=0}” is “e_{1|t=0}”<“e_{2|t=0}”. Under a situation where the switch at the time t=1 is likely to occur, the defocus amount “e_{1|t=1}” of the person 1508 becomes a value (indicating the defocus amount on the front side) similar to “e_{2|t=0}”, which is the similar object 1505 at the time t=0. That is, when a past difference value is taken, the difference from the person 1505, who is the similar object, is smaller. Therefore, when the degree of similarity is calculated in accordance with Expression (1), a degree L1 of similarity between the person 1508 and the person 1504, who is the past tracking target, is as in Expression (6). A degree L2 of similarity between the person 1508 and the person 1505, who is the past similar object, is as in Expression (7).

$$L 1 = - {W}_{1} ‖ {BB}_{1 \vert t = 1} - B {B}_{1 \vert t = 0} ‖ - {W}_{2} ‖ {f}_{1 \vert t = 1} - {f}_{1 \vert t = 0} ‖ - {W}_{3} ‖ {e}_{1 \vert t = 1} - {e}_{1 \vert t = 0} ‖ \qquad ( 6 )$$

$$L 2 = - {W}_{1} ‖ {BB}_{1 \vert t = 1} - B {B}_{2 \vert t = 0} ‖ - {W}_{2} ‖ {f}_{1 \vert t = 1} - {f}_{2 \vert t = 0} ‖ - {W}_{3} ‖ {e}_{1 \vert t = 1} - {e}_{2 \vert t = 0} ‖ \qquad ( 7 )$$

Even when there is no difference between the feature amount and the BB in the calculation (i.e., in a case where there is almost no difference between the first term and the second term of Expressions (6) and (7)), a significant difference occurs in a past difference value of the defocus amount of the third term. That is, the third term of the degree L2 of similarity to the person 1505, who is the past similar object, has a value close to 0, and the third term of the degree L1 of similarity to the person 1504, who is the past tracking target, is larger. As a result, L1 is a negative value, L2 is in the vicinity of 0, and L1<L2. In a case of the degree of similarity calculated in accordance with Expression (1), matching with a larger value is performed. Therefore, the person 1508 is correctly matched with the person 1505, who is the past similar object, and no switch of the tracking target occurs.

As described above, according to the first embodiment, by tracking the object of the tracking target using depth information, it is possible to suppress an occurrence of erroneous tracking. In particular, in a case where the tracking target and a similar object are close to each other in the depth direction, it is possible to suppress an occurrence of erroneous tracking.

### Modification

As a modification, a method of further using reliability of depth information will be described. There is a case where the depth information is not necessarily accurate information due to disturbances such as noise. The same applies to a case of the defocus amount exemplified as depth information in the first embodiment. The distance measurement method described above with reference to FIG. 10 is based on the premise that image shapes of the image A and the image B are identical. Therefore, reliability is defined based on a coincidence degree between the image shapes of the image A and the image B.

In a case where reliability information on the defocus amount is obtained (reliability is obtained) in each cell of the defocus map described above, this information is used to determine the degree to which the defocus amount is considered. Specifically, in a case where the reliability of the defocus amount is high, a coefficient W₃ of the past difference value of the defocus amount of the third term defined by Expression (1) is set to a predetermined value. On the other hand, in a case where the reliability of the defocus amount is low, the coefficient W₃ is set to a value lower than the predetermined value. By this, in a case where the reliability of the depth information is low, by suppressing consideration of the depth information when performing degree of similarity calculation, it is possible to reduce erroneous tracking due to erroneous depth information. Note that in a case where the reliability of the defocus amount is less than a predetermined value, the coefficient W₃ may be set to zero.

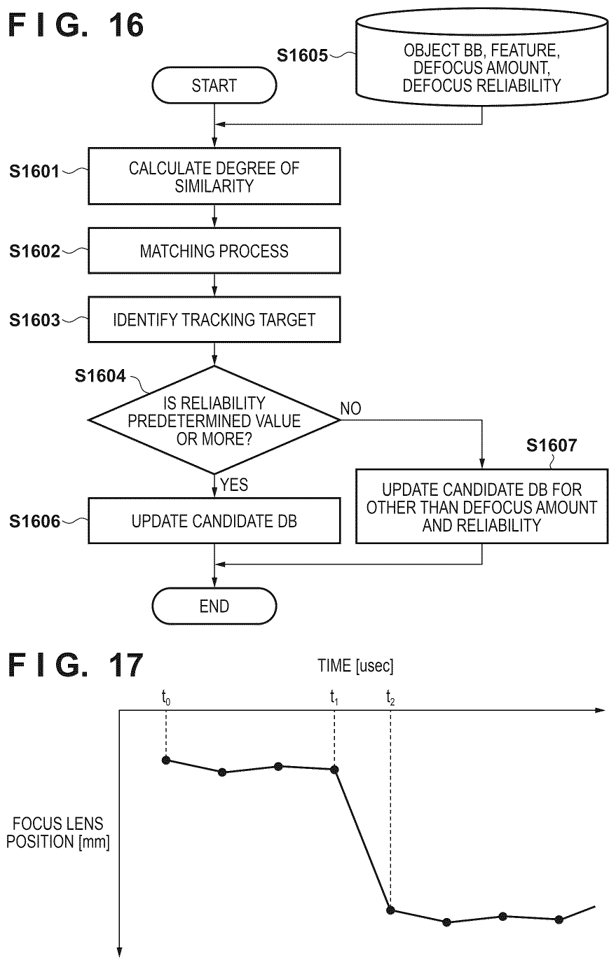

FIG. 16 is a detailed flowchart of S306 in a case of using the reliability of the depth information. Note that description of similar parts to those in the first embodiment (FIG. 9) will be omitted.

In S1604, the tracking target identification unit 207 determines whether the reliability of the current candidate of the defocus amount is the predetermined value or more. If the reliability is the predetermined value or more, the process proceeds to S1606, and if the reliability is less than the predetermined value, the process proceeds to S1607.

In S1606, the tracking target identification unit 207 updates the BBs, the features, the defocus amounts, and the reliabilities of the defocus amounts of the tracking target and the candidate thereof stored in the DB in S1605. On the other hand, in S1607, the tracking target identification unit 207 does not update the information on the defocus amounts and the reliabilities of the defocus amounts of the tracking target and the candidate thereof stored in the DB in S1605, and updates only the BBs and the features.

By performing this processing, the depth information at the time point where the reliability is low is discarded, and an effect of reducing erroneous tracking due to erroneous depth information is obtained.

Note that regarding the setting of a coefficient corresponding to the reliability of depth information, in the present embodiment, if the reliability is obtained as a discrete value, each coefficient is empirically set in accordance with the reliability, but the present disclosure is not limited to this. For example, if the reliability is a continuous amount, the coefficient may be set as the continuous amount accordingly. A coefficient corresponding to the reliability of the depth information may be obtained from the result of the tracking learning described above.

As described above, according to the modification, the tracking target is identified by further using the reliability information on the depth information. This can suppress erroneous tracking also in a case where there is a disturbance influence on the depth information.

### Second Embodiment

In the second embodiment, a method of using state information regarding an operation state of an image capturing apparatus connected to an information processing apparatus will be described. In particular, a form of obtaining information on a focus lens driving amount as an operation state and updating depth information will be described.

In an image capturing apparatus (e.g., single lens camera), a shooter performs zooming, focusing, framing, or the like during shooting, whereby an operation state of the image capturing apparatus is likely to rapidly change. There is a case where such a rapid change in the operation state also affects depth information obtained from the image capturing apparatus. In the present embodiment, even in such a situation, stable tracking can be achieved using depth information.

FIG. 17 is a view illustrating a temporal change of a focus lens position of the image capturing apparatus. Here, shooting is started from time to. In the period from time t₀ to time t₁, the position of the focus lens is substantially unchanged, and the lens driving amount is small. In the period from time t₁ to time t₂, the focus lens position greatly changes, and the lens driving amount is large. As described above with reference to FIG. 10, since the defocus amount is a deviation in the image forming plane, it is a relative value with respect to the lens position. Therefore, it is not possible to simply compare the defocus amounts before and after the focus lens moves greatly.

Therefore, it is possible to use a method of obtaining (state obtainment) information regarding the driving amount of the focus lens from the image capturing apparatus and setting the weight W₃ of the degree of similarity calculation defined by Expression (1) depending on the lens driving amount. For example, in a case where the lens driving amount is large, by setting the weight to be small, it is possible to reduce erroneous tracking due to erroneous depth information.

As another method, a method of multiplying the lens driving amount by a predetermined conversion coefficient and converting it into an image plane distance may be used. Here, the conversion coefficient is an amount varying depending on an image capturing optical system such as a focus lens. By dividing the calculated image plane distance by the product [Fδ] of the aperture F number and the permissible circle of confusion diameter δ in the image capturing apparatus optical system, it is possible to convert it into the defocus amount. Information on the defocus amount of the current candidate or the past candidate is updated based on a defocus conversion value of this lens driving amount, and a difference value between the past and current defocus amounts can be obtained in the degree of similarity calculation.

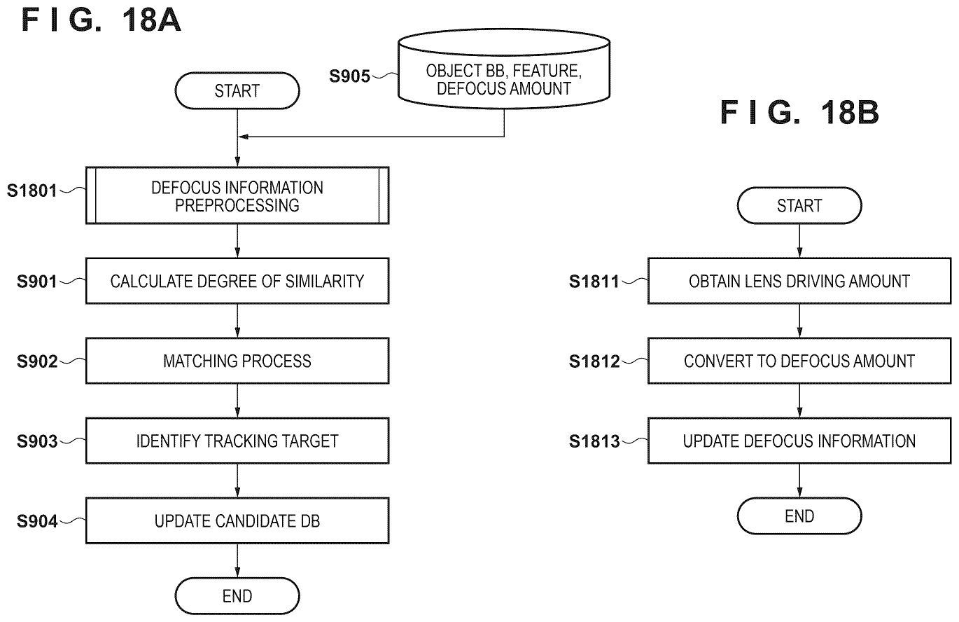

FIGS. 18A and 18B are detailed flowcharts of S306 in the second embodiment. FIG. 18A shows an overall flow in a case of updating the defocus information based on the lens driving amount, and FIG. 18B shows a detailed flow of S1801. Note that description of parts overlapping with the flow of the first embodiment (FIG. 9) will be omitted. In S1801, the tracking target identification unit 207 performs preprocessing of the defocus information based on the lens driving amount.

In S1811, the tracking target identification unit 207 obtains the lens driving amount from the image capturing apparatus. The information regarding the lens driving amount of the image capturing apparatus is obtained via the communication unit 107. In S1812, the tracking target identification unit 207 converts the lens driving amount into the defocus amount. In S1813, the defocus amount of the past candidate or the current candidate is added or subtracted based on the converted defocus amount, thereby performing conversion (correction).

S901 and thereafter are similar to those of the first embodiment, but a difference between the current candidate and the past candidate of the defocus amount is obtained using the converted defocus amount (corrected depth).

As described above, according to the second embodiment, the defocus amount is calculated (converted) based on the lens driving amount between frame images on which the tracking processing is performed. By this, even in a case where the operation state of the image capturing apparatus greatly changes between the frame images subjected to tracking processing and the accuracy of the depth information is affected, it is possible to suppress an occurrence of erroneous tracking.

### Third Embodiment

In the third embodiment, a method of determining an appropriate partial region for obtaining a feature amount of a tracking target candidate using depth information will be described. In particular, a form of achieving obtainment of a more accurate feature amount of each candidate in a case where a tracking target and a similar object are positioned so as to overlap each other back and forth in the depth direction will be described.

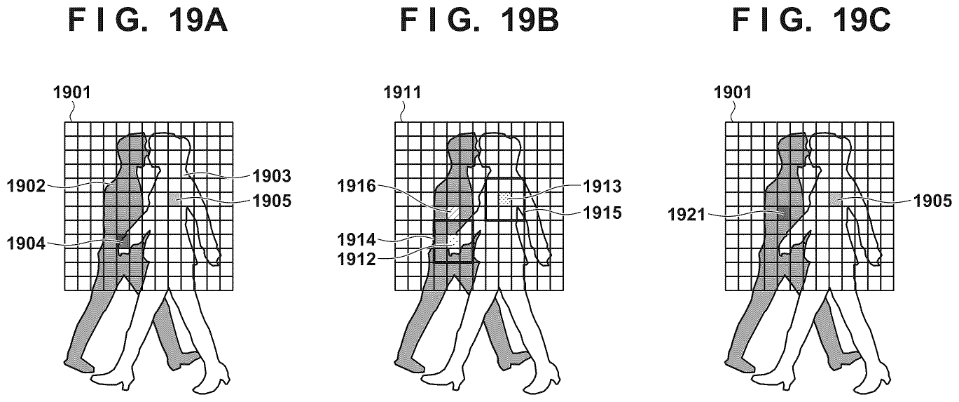

FIGS. 19A to 19C are views describing updating of a feature amount obtainment position (region determination of a partial region used for feature derivation) using depth information. A map 1901 in FIG. 19A illustrates a map obtained from a cross-correlation calculation result of CNN features between a template and a search range. From this result, a case where it is estimated that a person 1902 who is a candidate exists at the position of a cell 1904 and a person 1903 exists at the position of a cell 1905 is considered. At this time, the position of the cell 1904 significantly includes a region of the person 1903, and if the feature amount is obtained from this result, there is a possibility that the feature of the person 1902 cannot be captured well.

FIG. 19B is a view describing the updating of the obtainment position of the feature amount of the person 1902 using a defocus map 1911. Cells 1912 and 1913 in FIG. 19B indicate the defocus amounts at the positions of the cells 1904 and 1905 in FIG. 19A, respectively. The defocus amount of the person 1902 is obtained from the mean value of a region 1914 including peripheral cells of the cell 1912, and the defocus amount of the person 1903 is obtained from the mean value of a region 1915 including peripheral cells of the cell 1913. From this result, it is possible to determine that both the cells 1904 and 1905, which are the positions where the feature amounts of the respective candidates are to be originally obtained, are in the vicinity of the defocus amount of the person 1903.

Therefore, the obtainment position of the feature amount is updated to a position in the vicinity of the defocus amount of the person 1902 obtained from the mean value of the region 1914. As the position to be updated, it is assumed that a cell 1916 of “a region in the vicinity of the defocus amount of the person 1902” and “a position closest to the position of the cell 1904 in terms of distance” in the defocus map 1911 is appropriate.

FIG. 19C illustrates a result of updating the obtainment position of the feature amount of the person 1902 to a cell 1921. This processing enables the feature amount of each candidate to be correctly obtained.

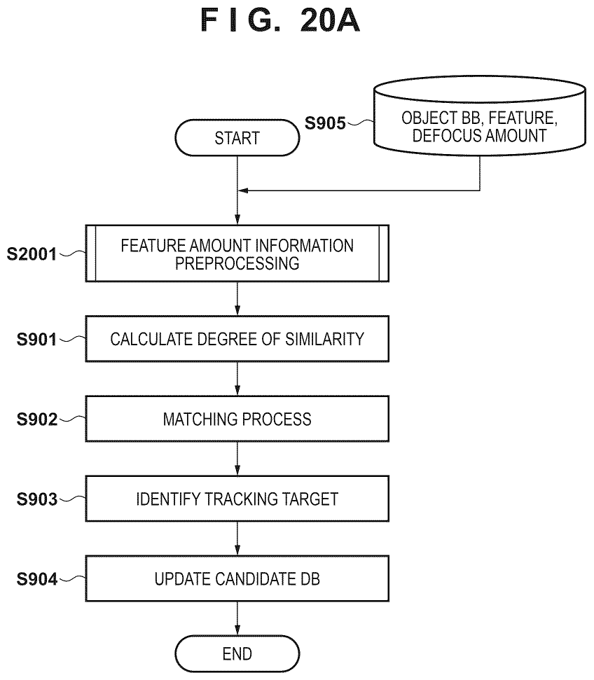

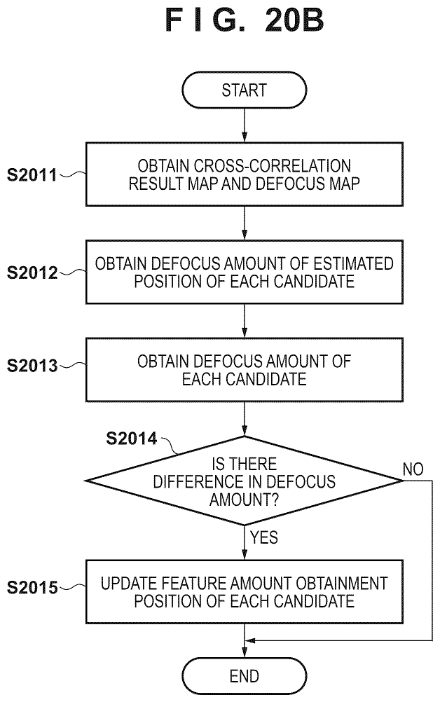

FIGS. 20A and 20B are detailed flowcharts of S306 in the third embodiment. FIG. 20A shows an overall flow of the updating processing of the feature amount information using a defocus map, and FIG. 20B shows a detailed flow of S2001. Note that description of parts overlapping with the flow of the first embodiment (FIG. 9) will be omitted. In S2001, the tracking target identification unit 207 performs updating processing of the feature amount information.

In S2011, the tracking target identification unit 207 obtains a map of a cross-correlation calculation result of CNN features between a template and a search range and a defocus map.

In S2012, the tracking target identification unit 207 obtains the defocus amount of an estimated position (=position where the feature amount information is obtained) of each candidate from the cross-correlation result map obtained in S2011 and the defocus map.

In S2013, the tracking target identification unit 207 obtains the defocus amount of each candidate. As described in the first embodiment, the method of obtaining the defocus amount of each candidate is not limited to the method of obtaining it from the vicinity of the candidate range of each candidate described above, and may be an estimation result using a defocus inference unit. The defocus amount may have not a value at one point but a maximum/minimum value as a value for a range in which the subject exists. Furthermore, in a case where depth information is used, depth information on a region where the subject exists may be obtained by depth estimation or the like.

In S2014, the tracking target identification unit 207 determines whether there is a difference between the defocus amount of each candidate and the defocus amount at the estimated position of each candidate. In a case where the difference is a predetermined value or more, the process proceeds to S2015, and in a case where the difference is less than the predetermined value, the process ends.

In S2015, the tracking target identification unit 207 updates the position where the feature amount information is obtained from the estimated position of each candidate. Here, the condition of the position to be updated is a region in which “the difference in the defocus amount is within a predetermined value” and of “the closest position to the original estimated position of each candidate”. The condition of the position to be updated is not limited to this, and for example, the reliability information on the defocus amount described above may be used to limit to a region where the reliability is a certain level or more. The width and height information on each BB estimated for each candidate may be used to limit the position to be updated to the inside of the BB region.

As described above, according to the third embodiment, an appropriate position for obtaining the feature amount of the tracking target candidate is updated using the depth information. By this, even in a case where the tracking target and the similar object are positioned so as to overlap with each other, it is possible to obtain a more accurate feature amount of each candidate, and it is possible to suppress an occurrence of erroneous tracking.

According to the present disclosure, it is possible to provide a technique that enables more accurate subject tracking.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-213835, filed Dec. 6, 2024, which is hereby incorporated by reference herein in its entirety.

What is claimed is:

1. An information processing apparatus comprising:
at least one processor; and
at least one memory having stored thereon instructions which, when executed by the at least one processor, causing the information processing apparatus at least to:
obtain a frame image included in a moving image,
obtain depth information regarding a depth in each region in the frame image,
set a tracking target,
detect one or more tracking candidates similar to the tracking target from the frame image, and
identify the tracking target from the one or more tracking candidates based on a degree of similarity between the tracking target in a past frame image preceding the frame image and each of the one or more tracking candidates in the frame image, wherein
the degree of similarity is based on at least one of a first degree of similarity between a depth of the tracking target in the past frame image and a depth of each of the one or more tracking candidates, a second degree of similarity between position and size of a bounding box (BB) of the tracking target in the past frame image and position and size of a BB of each of the one or more tracking candidates, and a third degree of similarity between an image feature of the tracking target in the past frame image and an image feature of each of the one or more tracking candidates.

2. The information processing apparatus according to claim 1, wherein
the first degree of similarity is based on a difference between a depth of the tracking target in the past frame image and a depth of each of the one or more tracking candidates.

3. The information processing apparatus according to claim 1, wherein
the instructions cause the information processing apparatus to obtain information regarding reliability of the depth information, and
a weight of the first degree of similarity in calculation of the degree of similarity is set based on the reliability.

4. The information processing apparatus according to claim 3, wherein
in a case where the reliability is less than a predetermined value, the weight of the first degree of similarity is set to zero.

5. The information processing apparatus according to claim 1, wherein
the instructions cause the information processing apparatus to obtain state information regarding an operation of an image capturing apparatus that has generated the moving image, and
a weight of the first degree of similarity in calculation of the degree of similarity is set based on the operation in a period between the past frame image and the frame image.

6. The information processing apparatus according to claim 5, wherein
the state information is information on a driving amount of a focus lens in the image capturing apparatus.

7. The information processing apparatus according to claim 6, wherein
the degree of similarity is at least based on a first degree of similarity between a corrected depth in which the depth of the tracking target in the past frame image is corrected based on the information on the driving amount and the depth of each of the one or more tracking candidates.

8. The information processing apparatus according to claim 1, wherein
the instructions cause the information processing apparatus to determine a partial region in the frame image to be used for derivation of an image feature of each of the one or more tracking candidates based on the depth of each of the one or more tracking candidates.

9. The information processing apparatus according to claim 1, wherein
the depth information is a defocus amount obtained by an image capturing apparatus that has generated the moving image.

10. A control method of an information processing apparatus that tracks a tracking target in a moving image, the control method comprising:
setting the tracking target;
obtaining a frame image included in the moving image;
obtaining depth information regarding a depth in each region in the frame image;
detecting one or more tracking candidates similar to the tracking target from the frame image; and
identifying the tracking target from the one or more tracking candidates based on a degree of similarity between the tracking target in a past frame image preceding the frame image and each of the one or more tracking candidates in the frame image, wherein
the degree of similarity is based on at least one of a first degree of similarity between a depth of the tracking target in the past frame image and a depth of each of the one or more tracking candidates, a second degree of similarity between position and size of a bounding box (BB) of the tracking target in the past frame image and position and size of a BB of each of the one or more tracking candidates, and a third degree of similarity between an image feature of the tracking target in the past frame image and an image feature of each of the one or more tracking candidates.

11. A non-transitory computer-readable recording medium storing a program that, when executed by a computer, causes the computer to perform a control method of an information processing apparatus that tracks a tracking target in a moving image, the control method comprising:
setting the tracking target;
obtaining a frame image included in the moving image;
obtaining depth information regarding a depth in each region in the frame image;
detecting one or more tracking candidates similar to the tracking target from the frame image; and
identifying the tracking target from the one or more tracking candidates based on a degree of similarity between the tracking target in a past frame image preceding the frame image and each of the one or more tracking candidates in the frame image, wherein
the degree of similarity is based on at least one of a first degree of similarity between a depth of the tracking target in the past frame image and a depth of each of the one or more tracking candidates, a second degree of similarity between position and size of a bounding box (BB) of the tracking target in the past frame image and position and size of a BB of each of the one or more tracking candidates, and a third degree of similarity between an image feature of the tracking target in the past frame image and an image feature of each of the one or more tracking candidates.
